(19) United States
(12) Patent Application Publication
(10) Pub. No.: US 2016/0169774 A1
(43) Pub. Date: Jun. 16, 2016

(54) FUNNEL SAMPLE COLLECTOR

(71) Applicant: PETROFUNNELS LLC, Forth Worth, TX (US)

(72) Inventor: Heath DRAGER, Fort Worth, TX (US)

(21) Appl. No.: 14/965,455

(22) Filed: Dec. 10, 2015

Related U.S. Application Data
(60) Provisional application No. 62/091,275, filed on Dec. 12, 2014.

(51) Int. Cl. G01N 1/12

(52) U.S. Cl. CPC G01N 1/12

(57) ABSTRACT

A funnel sample collector is adapted to freestandingly support a sample bottle and allow for it to be filled from a sampler such as a zone or Petro View sampler while preventing spills, drips, and accidents. By moving the funnel sample collector between multiple bottles, they can be filled quickly, reducing time spent collecting the samples. An actuator is positioned to close the bottom of the funnel of the funnel sample collector when a sampler is not being dispensed thereinto. Flanges within the funnel prevent splashing. The funnel sample collector may be disassembled to allow for proper cleaning to prevent cross contamination.

### CROSS REFERENCE TO RELATED APPLICATIONS

This applications claims priority to U.S. Provisional Patent Application No. 62/091,275, filed on Dec. 12, 2014, the entirety of which is incorporated herein by reference.

### TECHNICAL FIELD/FIELD OF THE DISCLOSURE

The present disclosure relates generally to sampling of liquids in liquid storage tanks, and specifically to the collection and bottling of liquids taken from a liquid storage tank by a sampling device.

### BACKGROUND OF THE DISCLOSURE

In the business of buying and selling liquids, ensuring the composition and quality of the product stored or transferred is essential. In order to sample the product, a spot or running sample is taken from the liquid in the tank and is taken to a laboratory for testing. In the course of a single transfer, load, discharge, or lightering operation, a large number of samples may be taken. For example, samples may be taken from one or more land tanks or from one or more tanks on a vessel or barge. Samples may be taken from the delivered product, from a base product, or from a blended product before, after, and during intermediate stages of the transfer operation. Furthermore, multiple samples may be taken from a single tank at different depths in the tank to ensure proper product quality.

Typically, samples are taken either at a particular depth in a tank, a spot sample, or include liquid from a range of depths. As an example, a zone sampler as understood in the art, used to take a spot sample, generally includes a tube having an upper and lower flapper valve. As the zone sampler is lowered into the liquid in the tank by a rope or line, the flapper valves open allowing liquid to flow through the tube. When stopped at the desired depth in a storage tank and as the zone sampler is retrieved, the flapper valves close, retaining liquid from the depth at which the zone sampler was stopped. Once retrieved, the sampler is emptied into a sample bottle which is taken to the lab for testing. However, the process by which the sampler is emptied into the sample bottle may cause liquid to be spilled, and due to the nature of the sampler, may not be convenient to carry out quickly and without creating unnecessary mess.

### SUMMARY

The present disclosure provides for a funnel sample collector for filling a sample bottle from a sampler. The funnel sample collector may include a funnel assembly, the funnel assembly including a funnel and a spout. The funnel sample collector may include a stand, the stand adapted to support the funnel assembly above the sample bottle and position the spout within a neck of the sample bottle. The funnel sample collector may further include an actuator assembly. The actuator assembly may include a valve stem and a valve head. The valve stem may extend through the funnel assembly. The valve head may form a fluid seal against the spout of the funnel assembly when in a closed position. The valve stem may be biased into the closed position by a spring. The valve stem may be adapted to contact and open a lower valve of the sampler and be forced into the opened position by the sampler allowing liquid dispensed from the sampler to flow into the sample bottle.

The present disclosure also provides for a method. The method may include providing a sample bottle and a funnel sample collector. The funnel sample collector may include a funnel assembly, the funnel assembly including a funnel and a spout. The funnel sample collector may include a stand, the stand adapted to support the funnel assembly above the sample bottle and position the spout within a neck of the sample bottle. The funnel sample collector may further include an actuator assembly. The actuator assembly may include a valve stem and a valve head. The valve stem may extend through the funnel assembly. The valve head may form a fluid seal against the spout of the funnel assembly when in a closed position. The valve stem may be biased into the closed position by a spring. The method may include positioning the funnel sample collector onto the sample bottle. The method may further include sampling a liquid in a storage tank with a sampler having a lower flapper valve; contacting the actuator assembly with the lower flapper valve; opening the lower flapper valve; allowing liquid in the sampler to enter the funnel assembly; and forcing the actuator assembly downward into an open position, allowing the liquid to enter the sample bottle.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a perspective view of a funnel sample collector consistent with embodiments of the present disclosure.

FIG. 2 is an exploded cross section view of a funnel sample collector consistent with embodiments of the present disclosure.

FIG. 3 is a cross section view of the funnel sample collector of FIG. 2.

FIG. 4 is a top-view of a funnel sample collector consistent with embodiments of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

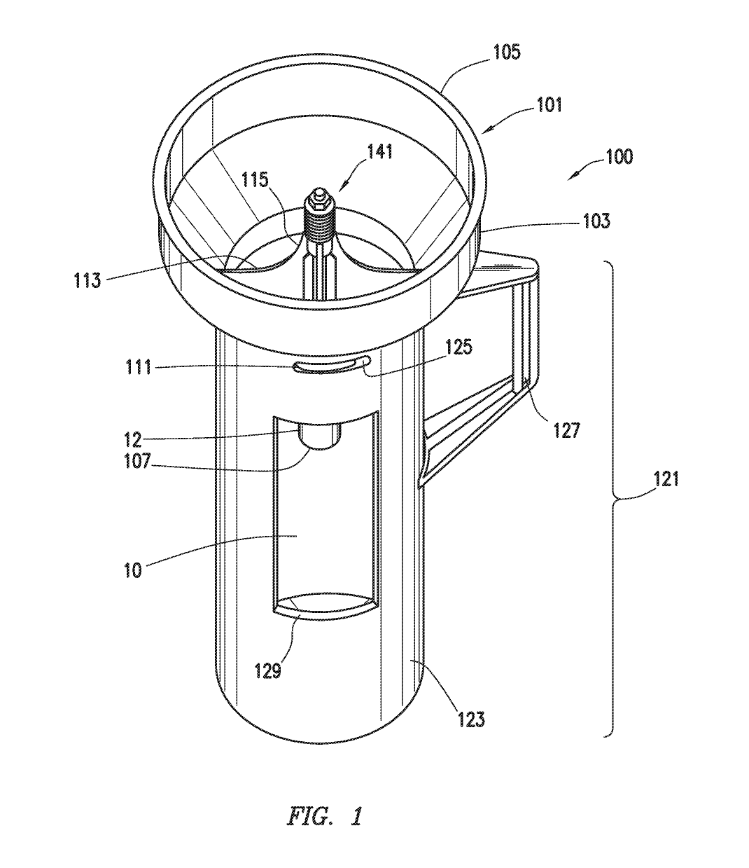

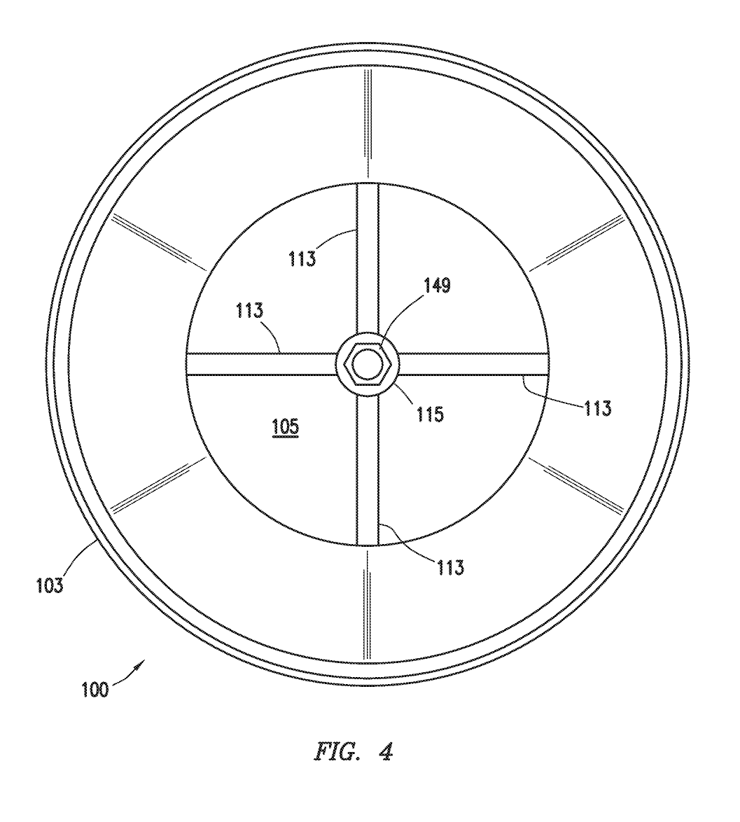

As depicted in FIGS. 1-4, funnel sample collector 100 may be used to assist with the transfer of a liquid from a sample collector (not shown) to sample bottle 10. In some embodiments, funnel sample collector 100 may be adapted to fit over sample bottle 10. In some embodiments, funnel sample collector 100 may include funnel assembly 101, stand 121, and actuator assembly 141.

In some embodiments, funnel assembly 101 may include funnel body 103. Funnel body 103 may be generally tapered from top opening 105 to spout 107. Funnel body 103 may be tapered in any way in order to, as understood in the art, allow liquid to be poured into the generally large diameter top opening 105 and to be collected and flow through the relatively small diameter spout 107. In some embodiments, the volume of funnel body 103 may be such that it is capable of holding at least the full volume anticipated to be dispensed from a sampler during normal operation. Although depicted herein as generally circular, one having ordinary skill in the art with the benefit of this disclosure will understand that funnel body 103 may be any shape, including, for example and without limitation, round, ellipsoid, rectangular, or indeed any shape and may be symmetrical or asymmetrical. Additionally, one having ordinary skill in the art with the benefit of this disclosure will understand that spout 107 need not be centrally located, as long as the interior surfaces of funnel body 103 are tapered and angled such that liquid poured thereinto is influenced to flow through spout 107.

In some embodiments, top opening 105 of funnel body 103 may be sized to, for example and without limitation, allow funnel assembly 101 to collect liquid which may drip from a sample collector between an access hatch and the location of sample bottle 10. As an example, if a top hatch to a liquid storage tank is opened, one or more sample bottles 10 may be positioned about the hatch a short distance (to prevent sample bottles 10 from falling into the liquid storage tank) from the hatch ready to collect samples from a sampler deployed through the hatch. When installed on each sample bottle 10, top opening 105 of funnel assembly 101 may, in some embodiments, be large enough to span the gap between the sample bottle 10 and the hatch, preventing liquid from dripping onto the floor surface between the hatch opening and the bottle.

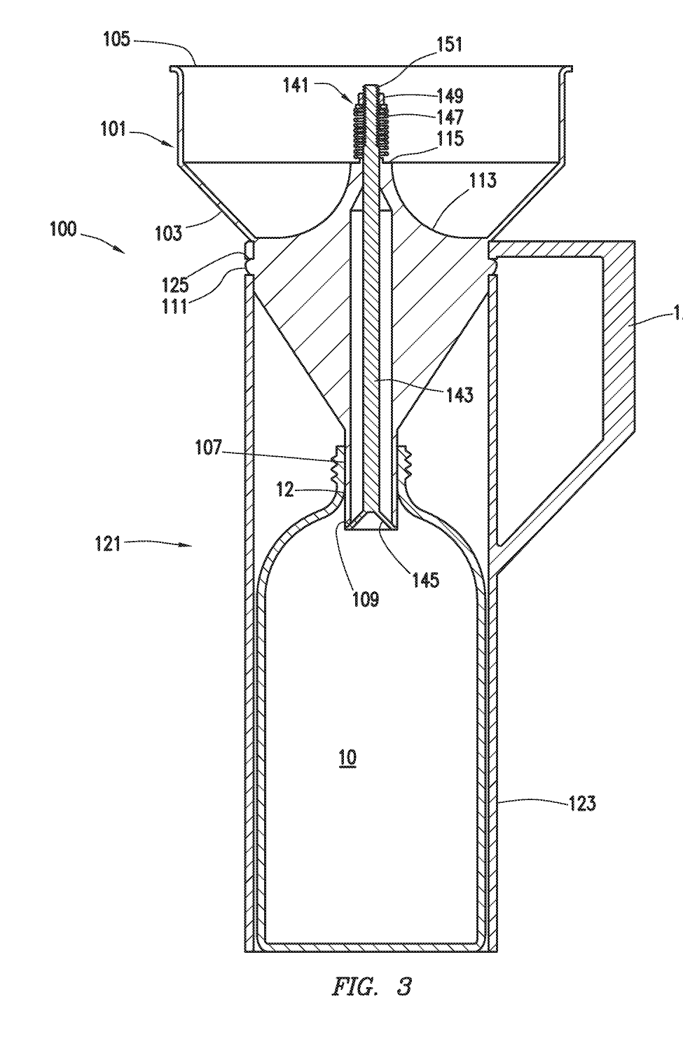

In some embodiments, spout 107 may be adapted to, as depicted in FIG. 3, fit into the neck 12 of sample bottle 10. In some embodiments, spout 107 may have a diameter less than the diameter of neck 12 to, for example and without limitation, allow air to escape from sample bottle 10 as a liquid is poured into sample bottle 10. In some embodiments, the length of spout 107 may be selected such that it passes entirely through the relatively narrow neck 12 of sample bottle 10 to, for example and without limitation, allow for efficient liquid flow into sample bottle 10.

In some embodiments, funnel assembly 101 may be supported by stand 121. Stand 121 may include stand body 123. Stand body 123 may be a generally tubular member adapted to fit around sample bottle 10. In some embodiments, funnel assembly 101 and stand 121 may be formed as a single unit. In some embodiments, funnel assembly 101 and stand 121 may be formed as separate components. In some embodiments, funnel assembly 101 may couple to stand 121 by a locking mechanism. The locking mechanism may allow, for example and without limitation, funnel assembly 101 and stand 121 to be moved as a single unit without unintentional separation while in use. Additionally, the locking mechanism may allow the selective decoupling of funnel assembly 101 from stand 121 in order to, for example and without limitation, allow for more thorough cleaning of components of funnel sample collector 100. The locking mechanism may be any suitable mechanism known in the art suitable for joining the two assemblies, including without limitation, a threaded connection, a twist-lock connection, a bayonet connection, a press-fit, one or more threaded couplers, or tabs and corresponding grooves or slots. For example and without limitation, in embodiments as depicted in FIGS. 1-3, funnel assembly 101 may include one or more locking tabs 111 adapted to fit into corresponding slots 125 formed in stand body 123.

In some embodiments, stand 121 may include handle 127 adapted to allow funnel sample collector 100 to be handled more easily as discussed herein below. In some embodiments, handle 127 may be formed integrally as a part of stand body 123 or may be formed as a separate component. Furthermore, although described as only coupling to stand 121, one having ordinary skill in the art with the benefit of this disclosure will understand that handle 127 may be coupled to any component of funnel sample collector 100, including, without limitation, funnel assembly 101, stand 121, or between funnel assembly 101 and stand 121.

In some embodiments, stand body 123 may include one or more windows 129. Windows 129 may be holes formed in stand body 123 to, for example and without limitation, allow air flow between sample bottle 10 and stand 121, and to allow visual inspection of sample bottle 10 when funnel sample collector 100 is placed thereon. Although depicted as being generally rectangular or oblong, one having ordinary skill in the art with the benefit of this disclosure will understand that windows 129 may be formed in any shape, number, arrangement, or configuration without deviating from the scope of this disclosure.

In some embodiments, as depicted in FIG. 3, stand body 123 may be of a selected diameter and height such that sample bottle 10 having known dimensions fits within the interior of stand body 123. In some embodiments, the internal diameter may be selected such that funnel sample collector 100 may be placed onto and removed from sample bottle 10 while sample bottle 10 is sitting on a floor surface. In some embodiments, funnel sample collector 100 may be placed onto and removed from sample bottle 10 without additional external support of sample bottle 10, allowing funnel sample collector 100 to be positioned and repositioned on sample bottle 10 and other sample bottles by one hand. In some embodiments, when placed over sample bottle 10, stand body 123 may support sample bottle 10, preventing, for example and without limitation, tipping or other disturbances of sample bottle 10 during a filling operation. In some embodiments, funnel sample collector 100 may be self-supporting on the floor surface, allowing sample bottle 10 to be filled without additional external support of funnel sample collector 100 and sample bottle 10.

In some embodiments, the shape of stand body 123 may be selected such that spout 107 of funnel assembly 101 is aligned with the mouth of sample bottle 10 as funnel sample collector 100 is placed thereon, allowing spout 107 to enter neck 12 of sample bottle 10 as previously discussed. In some embodiments, the height of stand body 123 may be selected such that when funnel sample collector 100 is placed onto sample bottle 10 with both sample bottle 10 and stand 121 in contact with the floor surface, spout 107 enters a specified amount into sample bottle 10. One having ordinary skill in the art with the benefit of this disclosure will understand that although described as in contact with a floor surface, sample bottle 10 may be placed on any suitable horizontal surface, and stand 121 may be in contact with any suitable horizontal surface including, for example and without limitation, a horizontal surface of sample bottle 10.

In some embodiments, funnel assembly 101 may be used with multiple configurations of stand 121, wherein each configuration of stand 121 is configured to be utilized with a specific shape of sample bottle 10. In some such embodiments, funnel assembly 101 may be decoupled from a first stand configured to be used with a first sample bottle configuration and may be coupled to a second stand configured to be used with a second sample bottle configuration. Such an embodiment may allow, for example and without limitation, a single funnel assembly 101 to be used with multiple sample bottle configurations having, for example and without limitation, different geometries, capacities, or specific filling requirements (such as requirements for the positioning of spout 107).

In some embodiments, funnel sample collector 100 may further include one or more flanges 113. Flanges 113 may be generally flat bodies positioned inside funnel body 103. In some embodiments, support flanges 113 may be configured to, for example and without limitation, slow or dissipate lateral momentum of liquids being poured into funnel body 103 and thus prevent or reduce splashing. In some embodiments, flanges 113 may be formed integrally with funnel body 103. In some embodiments, flanges 113 may be formed as a separate part from funnel body 103. In some embodiments, flanges 113 may be joined at their center to, for example, add structural rigidity to flanges 113. In some embodiments, flanges 113 may include upward extension 115 corresponding with a location generally within funnel body 103. In some embodiments, upward extension 115 may be configured to contact and open a lower valve of a sampler as previously discussed, allowing the contents of the sampler to be released into funnel sample collector 100, and thus enter into sample bottle 10. In some embodiments, flanges 113 may be positioned to support actuator assembly 141 as discussed herein below.

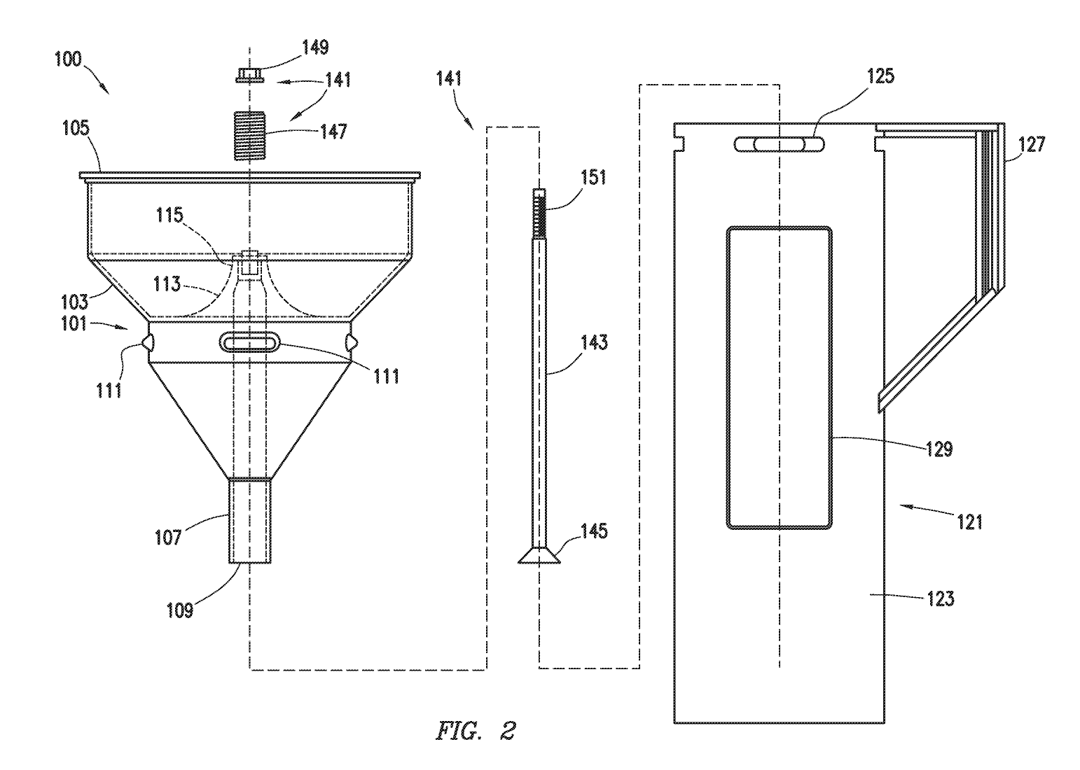

In some embodiments of the present disclosure, funnel sample collector 100 may further include actuator assembly 141. Actuator assembly 141 may act as a valve in order to, in some embodiments, prevent liquid flow from funnel sample collector 100 when in a closed position. In some embodiments, for example and without limitation, actuator assembly 141 may take the form of a poppet or mushroom valve as understood in the art. As depicted in FIGS. 2 and 3, actuator assembly 141 may, in some embodiments, include valve stem 143 having valve head 145 at its lower end. Valve stem 143 may extend generally vertically through funnel sample collector 100 such that the upper end of valve stem 143 is positioned within funnel body 103 and valve head 145 is positioned at spout 107. In some embodiments, valve stem 143 may be biased by spring 147 into a “closed” position.

In some embodiments, valve head 145, as understood in the art, may include a tapered upper surface and spout 107 may include valve seat 109, having a correspondingly tapered lower surface configured to form a liquid seal with valve head 145 when actuator assembly 141 is in the closed position. As understood in the art, one or more of valve head 145 and valve seat 109 may include one or more seals adapted to, for example and without limitation, improve the fluid seal therebetween.

In some embodiments, actuator assembly 141 may be supported by flanges 113 as previously discussed within funnel assembly 101. In some embodiments, flanges 113 may form a generally cylindrical bore through which valve stem 143 of actuator assembly 141 may pass.

In some embodiments, the upper end of valve stem 143 may be positioned at a location generally within funnel body 103. In some embodiments, the upper end of valve stem 143 may be configured to contact and open a lower valve of a sampler as previously discussed, allowing the contents of the sampler to be released into funnel sample collector 100, and thus enter into sample bottle 10. As the upper end of valve stem 143 contacts the lower valve of the sampler, the reaction force from the lower valve on valve stem 143 may cause valve stem 143 to move downward, moving actuator assembly 141 into the open position. The corresponding motion may cause valve head 145 to disengage from valve seat 109, allowing liquid flow from funnel assembly 101 through spout 107 and into sample bottle 10. When the sampler is removed from valve stem 143, spring 147 may bias actuator assembly 141 into the closed position, preventing any liquid within funnel assembly 101 from flowing dripping through spout 107. Liquid may thus be prevented from, for example and without limitation, dripping when funnel sample collector is moved from one sample bottle 10 to another. Additionally, if a sampler is discharged into funnel sample collector 100 when it is positioned atop a full or nearly full sample bottle 10, liquid flow may be arrested by disengaging the sampler from actuator assembly 141 until funnel sample collector 100 is positioned atop an empty sample bottle 10.

In some embodiments, the upper end of valve stem 143 may include a retention feature. The retention feature may be configured to, for example and without limitation, retain spring 147 between the retention feature and a portion of funnel assembly 101, such as flanges 113. In some embodiments, the retention feature may be formed as a permanent part of valve stem 143. In some such embodiments, the retention feature may, for example and without limitation, be a permanently attached bar, flange, rivet, or deformation of valve stem 143. In some embodiments, the retention feature may be selectively removable from valve stem 143. In such an embodiment, the retention feature may be a nut, cotter pin, clip, bolt, or any other device suitable for coupling to valve stem 143 capable of capturing spring 147. One having ordinary skill in the art with the benefit of this disclosure will understand that additional components, including washers, may be included between spring 147 and other components.

In some embodiments, as depicted in FIGS. 1-4, the retention feature may be retention nut 149 adapted to be threaded onto threads 151 formed on the upper end of valve stem 143. By tightening or loosening retention nut 149, the tension of spring 147 may be increased or decreased. By varying the tension of spring 147, the required opening force on valve stem 143 to open actuator assembly 141 may be varied. In some embodiments, the opening force may be varied with respect to properties of the liquid to be dispensed through funnel sample collector 100. As an example, a liquid having a high specific gravity or very low viscosity may require a higher spring tension to prevent the liquid from escaping between valve head 145 and valve seat 109. Alternatively, for a liquid of nominal density and viscosity, a lower spring tension may be desirable to, for example and without limitation, allow for simpler actuation of actuator assembly 141.

In some embodiments in which the retention feature is removable, actuator assembly 141 may be entirely removed from funnel sample collector 100. In some such embodiments, flanges 113 may remain in place, allowing upper extension 115 to contact and open the lower valve of a sample collector. In some embodiments, actuator assembly 141 may be removed by removing, for example, retention nut 149, allowing valve shaft 143 to slide downward and be removed from funnel assembly 101. By removing actuator assembly 141, for example and without limitation, the available bore area of spout 107 may be increased, and liquid may thus flow more freely therethrough. As an example, this increase in bore area may be desirable when a highly viscous or sticky liquid is poured through funnel sample collector 100. As the liquid is highly viscous, the decrease in wetted surface area and increase in cross-sectional flow area may allow for faster liquid transfer through funnel sample collector 100 into sample bottle 10. Additionally, being able to remove actuator assembly 141 may, for example, allow for simpler cleaning of funnel sample collector 100 after use.

In some embodiments in which flanges 113 are formed as a separate component from funnel body 103, by removing actuator assembly 141, flanges 113 may be removed from funnel assembly 101. In some such embodiments, flanges 113 may be removable to allow, as an example and without limitation, for easier cleaning of funnel assembly 101 and flanges 113 or for the use of funnel sample collector 100 to fill sample bottles 10 directly. In some embodiments, flanges 113 and actuator assembly 141 may be positionable within different funnel assemblies 101, adapted to be held in place by actuator assembly 141. In some such embodiments, funnel assembly 101 may be an otherwise unmodified funnel into which flanges 113 are adapted to fit and having spout 107 against which valve head 145 is adapted to seal.

In some embodiments, funnel sample collector 100 may further include a nozzle extension. The nozzle extension may be adapted to couple to nozzle 107 and extend the opening of nozzle 107 to a lower point within sample bottle 10. In some such embodiments, the nozzle extension may be adapted to prevent vapors from the liquid dispensed into sample bottle 10 from being forced out of sample bottle 10 as it is filled. In some embodiments, the nozzle extension may be removable from nozzle 107. In some embodiments, actuator assembly 141 may extend to the bottom of the nozzle extension.

In some embodiments, funnel sample collector 100 may further include a cap. The cap may be positioned to provide a general fluid seal between the sampler and funnel sample collector 100. In some embodiments, the cap may be formed from a pliable material and include one or more baffles adapted to contact the sampler.

As understood in the art, components of funnel sample collector 100 may be formed from any material capable of being utilized with anticipated liquids. For example and without limitation, components of funnel sample collector 100 may be formed from one or more of stainless steel, propylene plastic, any non-degradable plastic, brass, or mild steel.

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure and that they may make various changes, substitutions, and alterations herein without departing from the spirit and scope of the present disclosure.

1. A funnel sample collector for filling a sample bottle from a sampler comprising:
a funnel assembly, the funnel assembly including a funnel and a spout;
a stand, the stand adapted to support the funnel assembly above the sample bottle and position the spout within a neck of the sample bottle; and
an actuator assembly, the actuator assembly including a valve stem and a valve head, the valve stem extending through the funnel assembly, the valve head forming a fluid seal against the spout of the funnel assembly when in a closed position, the valve stem biased into the closed position by a spring, the valve stem adapted to contact and open a lower valve of the sampler and be forced into the opened position by the sampler allowing liquid dispensed from the sampler to flow into the sample bottle.

2. The funnel sample collector of claim 1, wherein the funnel assembly further comprises one or more flanges adapted to prevent splashing of a liquid when dispensed into the funnel assembly.

3. The funnel sample collector of claim 1, wherein the actuator assembly comprises a retainer nut adapted to increase or decrease tension on the spring to increase or decrease the force required to open the actuator assembly.

4. The funnel sample collector of claim 1, wherein the nozzle extends into the neck of the sample bottle.

5. The funnel sample collector of claim 1, further comprising a cap adapted to form a general fluid seal between the funnel assembly and the sampler.

6. The funnel sample collector of claim 1, further comprising a nozzle extension adapted to dispense the liquid into the sample bottle at a lower location.

7. The funnel sample collector of claim 1, further comprising a handle.

8. The funnel sample collector of claim 1, wherein the stand is adapted to properly align the spout with the sample bottle.

9. The funnel sample collector of claim 1, wherein the funnel assembly is formed as a separate unit from the stand, and is selectively coupleable to the stand by a locking assembly.

10. The funnel sample collector of claim 1, wherein the actuator assembly is selectively removable from the funnel sample collector.

11. The funnel sample collector of claim 1, wherein the components of the funnel sample collector are formed from one or more of stainless steel, propylene plastic, any non-degradable plastic, brass, or mild steel.

12. A method comprising:
providing a sample bottle;
providing a funnel sample collector, the funnel sample collector including:
a funnel assembly, the funnel assembly including a funnel and a spout;
a stand, the stand adapted to support the funnel assembly above the sample bottle and position the spout within a neck of the sample bottle; and
an actuator assembly, the actuator assembly including a valve stem and a valve head, the valve stem extending through the funnel assembly, the valve head forming a fluid seal against the spout of the funnel assembly when in a closed position, the valve stem biased into the closed position by a spring,
sampling a liquid in a liquid storage tank with a sampler having a lower flapper valve;
contacting the actuator assembly with the lower flapper valve;
opening the lower flapper valve, allowing liquid in the sampler to enter the funnel assembly;
forcing the actuator assembly downward into an open position, allowing the liquid to enter the sample bottle.
